(19) United States
(12) Patent Application Publication
(10) Pub. No.: US 2007/0084051 A1
(43) Pub. Date: Apr. 19, 2007

(54) Methods of welding turbine covers and bucket tips

(75) Inventors: Andrew John Tomko, Glenville, NY (US); John Francis Nolan, Cobleskill, NY (US); Dennis William Roberts, Schenectady, NY (US)

Correspondence Address: NIXON & VANDERHYE P.C., 901 NORTH GLEBE ROAD, 11TH FLOOR, ARLINGTON, VA, 22203, US

(73) Assignee: General Electric Company, Schenectady, NY (US)

(21) Appl. No.: 11/251,861

(22) Filed: Oct. 18, 2005

(51) Int. Cl. B23P 15/04; B21K 25/00

(52) U.S. Cl. 29/889.21; 29/889.2; 29/889.22

(57) ABSTRACT

Bucket tips and covers for the bucket tips are robotically welded to one another. Profiles of the bucket tips are patterned on the covers and openings generally corresponding to those profiles are formed through the covers. The openings may be stepped to limit the penetration of the bucket tip into the cover and the weld material is robotically applied to fill the remainder of the cover opening unoccupied by the bucket tip. Alternatively, the bucket tips may have a shoulder to limit penetration of the bucket tips in the cover openings. The weld is then stress relieved and machined to form a continuous smooth outer surface.

### BACKGROUND OF THE INVENTION

The present invention relates to methods for welding one or more bucket tips and a cover for the bucket tips to one another and particularly relates to methods for reducing manufacture cycle time and cost of securing bucket tips and covers to one another, with concurrent improved quality of the assembled product.

In steam turbines, cover plates are typically secured to the tips of the turbine buckets by a peening process. For example, one or more tenons are formed on the tip of each bucket. Cover openings are formed, for example by pre-punching, and these cover openings generally correspond to the configuration of the tenons such that the cover openings receive the tenons. A single cover may have a plurality of openings for receiving the tenons of multiple bucket tips. Once the tenons are received in the cover openings, the tenons are peened for example in a radial direction to mushroom the metal onto the cover forming a mechanical connection between the cover and bucket tips.

The peening process is generally performed at room or elevated temperatures. However, the tenon peening process is complicated because the labor is intensive and requires an apprenticed or learned skill. That skill must be practiced with proficiency and repeatability. Accordingly, there has developed a need for a method of connecting bucket tips and covers which substantially decreases the cost and labor involved in providing the connection by simultaneously improving the quality of the assembly.

### BRIEF DESCRIPTION OF THE INVENTION

In a preferred embodiment of the present invention there is provided method of securing a cover and the tip of a turbine bucket to one another comprising the steps of patterning a profile of a bucket tip onto a cover; forming an opening in the cover substantially conforming to the bucket tip profile; inserting the bucket tip at least partially into the cover opening; and welding the bucket tip and cover to one another at least about the joint between the bucket tip and the cover.

In a further preferred embodiment hereof, there is provided a method of securing a cover and tips of turbine buckets to one another comprising the steps of forming an opening through the cover at circumferential locations therealong having profiles substantially conforming to the profiles of the bucket tips; disposing the bucket tips and cover such that at least portions of the bucket tips lie within the openings; welding the bucket tips and cover to one another at least about the joints between the respective bucket tips and the cover.

### BRIEF DESCRIPTION OF THE DRAWINGS

FIG. 1 is a fragmentary schematic illustration of a method for securing bucket tips and covers to one another in accordance with a preferred embodiment of the present invention;

FIG. 2 is an enlarged fragmentary cross sectional view through a finished weld between a bucket tip and a cover opening;

FIG. 3 is a view similar to FIG. 2 illustrating a further embodiment in which, prior to welding, a gage block is applied to fix the depth of penetration of the bucket tip in the cover opening; and

FIG. 4 is a view similar to FIG. 2 illustrating a still further embodiment of the present invention.

### DETAILED DESCRIPTION OF THE INVENTION

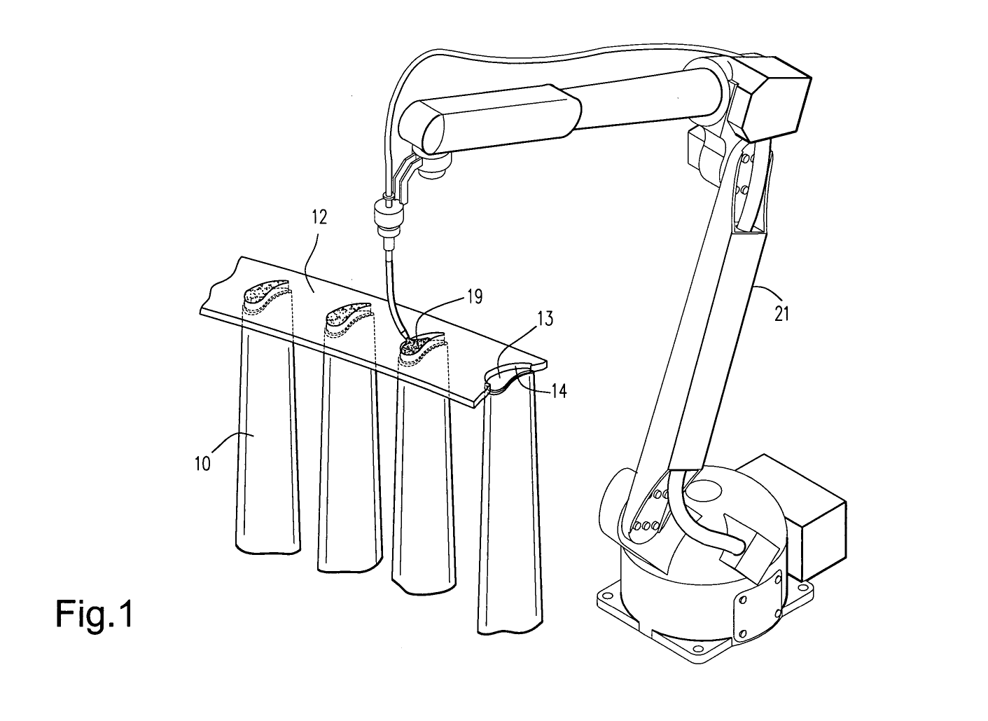

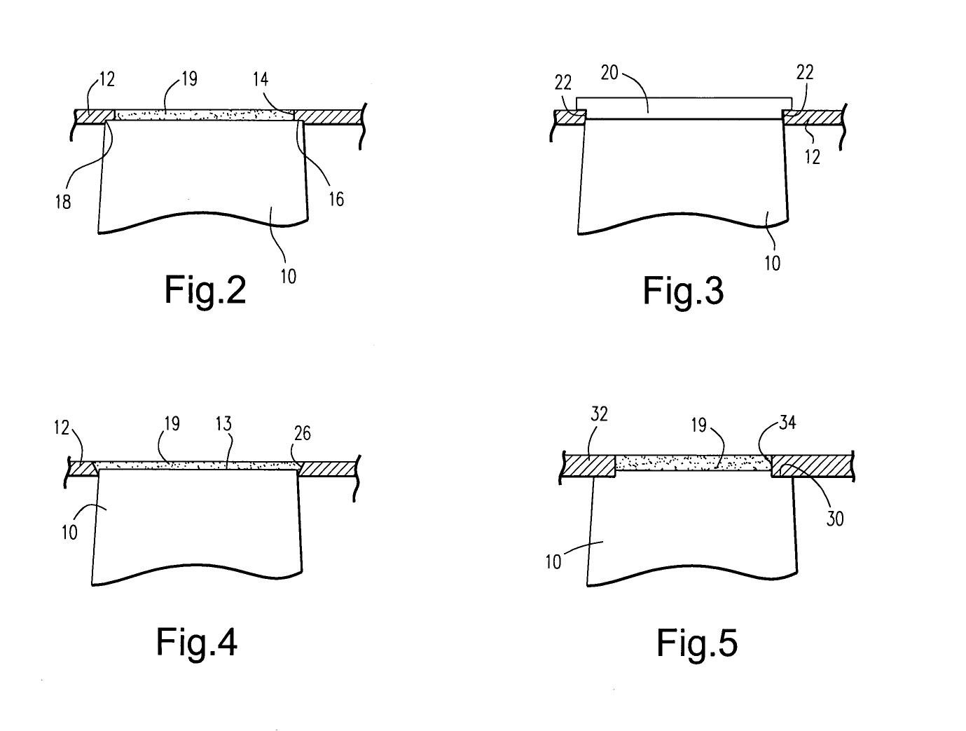

Referring now to the drawings, particularly to FIG. 1, there is illustrated a plurality of turbine buckets, for example steam turbine buckets 10, arranged in position for securement to a cover 12. As illustrated, a single cover 12 may span the tips 13 of a plurality of buckets, for example six buckets in number, although it will be appreciated that a single cover may be applied to each turbine bucket. Instead of forming one or more tenons on the tips of the buckets to project radially outwardly, the profile or pattern of the bucket tip is provided on the bucket cover. An opening 14 is then machined or otherwise formed on the cover in the profile of the bucket tip. The opening preferably extends from the radial inner face of the cover to the radial outerface of the cover, i.e. a through opening. As illustrated in FIG. 2, the opening 14 in the cover 12 is preferably formed with a step 16, the outer margin 18 of the step corresponding to the profile of the bucket tip. Consequently the depth of penetration of the bucket tip relative to the depth or thickness of the cover 12 is controlled and fixed by the extent of the recess 16 and which also sets the depth of the weld as described below.

With the one or more covers overlying the one or more bucket tips 13 and the latter being received within the cover openings 14 to a predetermined depth, the covers and bucket tips are welded one to the other. Preferably robotic welding is employed. It will be appreciated that various parameters of the welding process can be accurately controlled by robotic welding. For example, the current, arc length, angle of the electrode i.e. position of the torch, the gas flow rate of the shielding gas as well as the speed of travel of the electrode can be accurately controlled. This, of course, eliminates variations in those same parameters when manual welding is utilized even with highly skilled labor. Thus, with the covers 12 overlying the bucket tips and the bucket tips 13 received in the openings 14 at least to a limited extent, weld material 19 is applied around the margin of each opening 14 and the bucket tip 13 by the robotic welder 21. The weld material 19 also fills the remaining depth of the opening through the cover above or radially outwardly of the bucket tip once the weld is complete. Robotic welders 21 are known in the art and it will be appreciated that any one or more of known robotic welders may be used to weld the covers and bucket tips to one another. Once the robotic welding is complete, the weld is then stress relieved and machined to form a smooth continuous outer surface along the cover as illustrated in FIG. 2. The machining of the cover reduces erosion and provides a smooth surface for the application of a radial seal not shown. Finally, ultrasonic inspection of the weld is performed to ensure the quality of the weld.

Referring to FIG. 3, the opening formed through the cover may correspond to the profile of the bucket tip. To set the depth of penetration of the bucket tip 13 and the cover opening 14 relative to one another, a gage block 20 may be provided. The gage block 20 includes a step 22 along its underside which fits the cover opening 14 and penetrates the cover opening to a predetermined depth, limiting the depth of insertion of the bucket tip 13 into the cover opening 14. Upon removal of the gage block 20, the cover and bucket tip may be tack welded to one another to maintain the measured depth and welding may proceed similarly as described above with respect to FIGS. 1 and 2.

Referring to FIG. 4, the interior surface of the cover 12 may be patterned according to the profile of the bucket tip 13. The margins 26 of the opening 14 may taper radially outwardly and diverge from one another. This facilitates the welding process which may proceed with the robotic welding as described above with respect to FIG. 2.

In FIG. 5, a shoulder 30 is formed about the margin of the bucket tip. Shoulder 30 thus forms a groove or recess in the bucket tip which receives a margin of the cover 32 having an opening 34 complementary to the shape of the shoulder. Thus, the registering shoulder and cover openings align the buckets and covers to one another and set the depth for the weld. The shoulder 30 provides a stop limiting the depth of penetration of the bucket tip in the cover opening. Shoulder 30 substantially corresponds to the bucket tip profile.

It will be appreciated from the foregoing that there are many advantages to robotically welding the bucket tips and covers to one another. For example, standard tooling such as water jet cutting may be employed to cut or contour the shapes of the covers to accommodate the profiles of the bucket tips. The layouts, special cutters and forgings for forming the tenons are eliminated. Peening quality issues are also eliminated. Further advantages include a capability of ultrasonically testing the welded joints which cannot be done with peened joints. Moreover, the weld strength is greater than a peened mechanical joint. Further, radial seals can be applied after machining to the outer surfaces of the covers and overlying, as necessary the machined weld material. In final assembly, the replication of the bucket tip profiles in the covers controls the outer position and twist of the buckets, thereby providing a uniform location for the bucket tips such that the expanding steam passing through this bucket stage is uniform and consistent.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method of securing a cover and the tip of a turbine bucket to one another comprising the steps of:
(a) patterning a profile of a bucket tip onto a cover;
(b) forming an opening in the cover substantially conforming to the bucket tip profile;
(c) inserting the bucket tip at least partially into the cover opening; and
(d) welding the bucket tip and cover to one another at least about the joint between the bucket tip and the cover.

2. A method according to claim 1 including providing a step about at least a portion of the bucket tip forming a stop when engaged with the cover to limit the extent of insertion of the bucket tip into the cover.

3. A method according to claim 1 wherein step (c) includes limiting the depth of insertion such that the bucket tip lies recessed from an outer surface of the cover.

4. A method according to claim 3 including applying weld material to fill the recess in the cover.

5. A method according to claim 4 including machining the weld material to form a substantially smooth continuous surface with the outer surface of the cover.

6. A method according to claim 1 including stress relieving the bucket and cover subsequent to step (d).

7. A method according to claim 1 wherein step (d) is performed robotically.

8. A method of securing a cover and tips of turbine buckets to one another comprising the steps of:
(a) forming an opening through the cover at circumferential locations therealong having profiles substantially conforming to the profiles of the bucket tips;
(b) disposing the bucket tips and cover such that at least portions of the bucket tips lie within the openings;
(c) welding the bucket tips and cover to one another at least about the joints between the respective bucket tips and the cover.

9. A method according to claim 8 including providing a step between each of the bucket tips and cover forming stops when the bucket tips are engaged within the cover openings to limit the extent the bucket tips are received in the openings.

10. A method according to claim 9 including providing aid stops on each bucket tip.

11. A method according to claim 8 including limiting the extent to which the bucket tips lie within the openings such that the bucket tips lie recessed from an outer surface of the cover.

12. A method according to claim 11 including applying weld material in each recess.

13. A method according to claim 12 including machining the weld material to form substantially smooth continuous surfaces with the outer surface of the cover.
